(19) United States
(12) Patent Application Publication
(10) Pub. No.: US 2020/0021327 A1
(43) Pub. Date: Jan. 16, 2020

(54) TRANSMIT FILTER BYPASS FOR MULTI-ANTENNA TRANSCEIVER

(71) Applicant: QUALCOMM Incorporated, San Diego, CA (US)

(72) Inventors: Steven Charles CICCARELLI, San Diego, CA (US); Roberto RIMINI, San Diego, CA (US); Carl HARDIN, Encinitas, CA (US)

(21) Appl. No.: 16/035,369

(22) Filed: Jul. 13, 2018

(51) Int. Cl. H04B 1/525; H04B 1/18; H04W 72/08

(52) U.S. Cl. CPC H04B 1/525; H04W 72/082; H04B 1/18

(57) ABSTRACT

An method for wireless communication increases efficiency of its power amplifier (PA) by reducing an insertion loss of a filter (e.g., a transmit (Tx) filter). The method includes detecting, at a user equipment, a dominant spatial direction of interference. The method further includes determining whether to bypass a transmit filter based on an energy level associated with the dominant spatial direction of the interference.

### TECHNICAL FIELD

The present disclosure relates generally to wireless communications systems and, more specifically, to an opportunistic transmit filter bypass for a multi-antenna transceiver.

### BACKGROUND

Wireless communications systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3rd Generation Partnership Project (3GPP) long term evolution (LTE) systems, fifth generation technology (5G)), millimeter wave (mmW) technology (extremely high frequency (EHF)), and orthogonal frequency division multiple access (OFDMA) systems. In a millimeter wave (mmW) system, multiple antennas are used for beamforming (e.g., in the range of 30 gigahertz (GHz), 60 GHz, etc.).

Generally, a wireless multiple-access communications system can simultaneously support communication for multiple wireless terminals or devices (e.g., handsets or user equipments). Each terminal communicates with one or more base stations via transmissions on forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out, or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where NS≤min{NT, NR}. Each of the NS independent channels correspond to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when multiple antennas are available at the base station. In an FDD system, forward and reverse link transmissions are on different frequency regions.

In frequency division duplex (FDD) communications, duplexers are used to achieve simultaneous transmit-receive (Tx-Rx) communication while avoiding transmit self-leakage into a receive band. This phenomenon of transmit self-leakage into a receive band is also known as receive band noise (RxBN). The transmitter may support large frequency bands. To support the large frequency bands, a very complex duplexer is specified. The complex duplexer, however, significantly reduces efficiency of a power amplifier because of an inherent insertion loss of the transmit filter.

### SUMMARY

According to one aspect of the present disclosure, a method of wireless communication includes detecting, at a device, a dominant spatial direction of interference. The method also includes determining whether to bypass a transmit filter based on an energy level associated with the dominant spatial direction of the interference.

Another aspect discloses an apparatus for wireless communication, which includes a memory at least one processor coupled to the memory. The processor(s) is configured to detect, at a device, a dominant spatial direction of interference. The processor(s) is also configured to determine whether to bypass a transmit filter based on an energy level associated with the dominant spatial direction of the interference.

According to one aspect of the present disclosure, a method of wireless communication includes calculating a spatial covariance matrix when no incoming downlink signal is present. The method also includes selecting one or more spatial direction computed from the spatial covariance matrix associated with one or more first value corresponding to strength of an interference smaller than a second value corresponding to strength of a dominant interference. The method further includes combining a received signal across a set of antennas with the one or more selected spatial directions.

Yet another aspect discloses an apparatus for wireless communication and includes a memory at least one processor coupled to the memory. The processor(s) is configured to calculate a spatial covariance matrix when no incoming downlink signal is present. The processor(s) is also configured to select one or more spatial direction computed from the spatial covariance matrix associated with one or more first value corresponding to strength of an interference smaller than a second value corresponding to strength of a dominant interference. The processor(s) is also configured to combine a received signal across a set of antennas with the one or more selected spatial directions.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 shows a wireless device communicating with a wireless system.

FIG. 2 shows a block diagram of the wireless device in FIG. 1.

FIG. 3A illustrates a wireless transceiver architecture for implementing interference cancellation, according to aspects of the present disclosure.

FIG. 3B illustrates another wireless transceiver architecture for implementing interference cancellation, according to aspects of the present disclosure.

FIG. 4 is a graph illustrating spatial direction of Eigenvectors computed from a spatial covariance matrix based on interference from a transmit section of a user equipment, according to aspects of the present disclosure.

FIG. 5 illustrates a wireless transceiver architecture for implementing interference cancellation, according to aspects of the present disclosure.

FIGS. 6A and 6B each illustrate a graph of Eigenvalues associated with different spatial directions that correspond to potential direction of arrival of in-device interference, in accordance with aspects of the present disclosure.

FIG. 7 illustrates a wireless transceiver architecture for implementing interference cancellation, according to aspects of the present disclosure.

FIG. 8 illustrates a method of wireless communication according to aspects of the present disclosure.

FIG. 9 illustrates an interference cancellation method according to aspects of the present disclosure.

FIG. 10 is a block diagram showing an exemplary wireless communications system in which an aspect of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described herein, the use of the term “and/or” is intended to represent an “inclusive OR”, and the use of the term “or” is intended to represent an “exclusive OR”. As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations.

A wireless device (e.g., a user equipment) in a wireless communications system may include a radio frequency (RF) transceiver for transmitting and receiving data for two-way communication. A mobile RF transceiver may include a transmit section for transmitting data and a receive section for receiving data. For transmitting data, the transmit section may modulate an RF carrier signal with data to obtain a modulated RF signal, amplify the modulated RF signal to obtain an amplified RF signal having the proper output power level, and transmit the amplified RF signal via an antenna to a base station. For receiving data, the receive section may obtain a received RF signal via the antenna. The receive section may amplify and process the received RF signal to recover data sent by a base station.

The transmit section may include one or more circuits for amplifying and transmitting the communication signal. The amplifier circuits may include one or more amplifier stages (e.g., power amplifier stages) that may include one or more driver amplifiers and one or more power amplifiers. A power amplifier may include one or more stages including, for example, driver stages, power amplifier stages, or other components, that can be configured to amplify a communication signal on one or more frequencies, in one or more frequency bands, and at one or more power levels.

In frequency division duplex (FDD) communications, duplexers are used to achieve simultaneous transmit-receive (Tx-Rx) communication while avoiding transmit self-leakage into a receive band. These duplexers include filters for transmitting and receiving. This phenomenon of transmit self-leakage into a receive band is also known as receive band noise (RxBN).

A duplexer includes two filters (e.g., a transmit filter and a receive filter) with different objectives. The transmit filter protects a receiver from being jammed by noise from a transmitter. For example, the transmit filter limits emissions or noise from the transmitter. The transmit noise may include noise associated with a power amplifier (PA), noise associated with a wireless transmitter-receiver/software defined radio (WTR/SDR) and/or noise associated with a digital-to- analog converter (DAC). In addition, the transmit filter reduces out-of-band (OOB) emissions to meet 3rd Generation Partnership Project (3GPP) specifications. The receive filter attenuates a transmit signal at its fundamental frequency but is harmless against the transmit noise. The transmit noise is referred to as a receive band noise (RxBN) because it falls in the receive band and can significantly de-sense the receiver.

The transmitter may support large frequency bands. To support the large frequency bands, a very complex duplexer is specified. The complex duplexer, however, may reduce efficiency of a power amplifier because of an inherent insertion loss of the transmit filter. For example, the duplexer introduces insertion loss in a communication path (e.g., a transmit path and/or a receive path). This follows because the duplexer is placed after the power amplifier and in close proximity to an antenna. Thus, all of the energy from the power amplifier is provided to the duplexer. Because the duplexer is designed to achieve increased rejection, they are subject to insertion loss as a tradeoff to the increased rejection. For example, about half of the energy or power (e.g., 3 dB) provided to the duplexer could be lost. In some scenarios, to overcome this power loss, the power amplifier operates at higher power, which results in an inefficient utilization of battery energy and may even create uncomfortable heat in a hand held device or user equipment.

Aspects of the present disclosure are directed to increasing the efficiency of a power amplifier (PA) by reducing an insertion loss associated with use of a filter (e.g., a transmit (Tx) filter) in certain operating conditions. The efficiency may be achieved by enabling a bypass mode where a transmit filter is selectively bypassed based on an operating condition. In one aspect of the disclosure, the bypass mode can be enabled based on a favorable Eigen structure of the receive band noise interference resulting from bypassing the Tx filter. Potential current savings can also be taken into consideration to enable Tx filter bypass. In the bypass mode, a digital technique (e.g., digital baseband technique) can be implemented in a digital domain of the wireless transceiver architecture to mitigate the noise interference at the receive section. An antenna control device may provide control signals to selectively enable an additional receive antenna based on whether the bypass mode is enabled.

In some implementations, an increased power consumption associated with running the additional antenna and corresponding receive path including an analog-to-digital converter (ADC) is about eighty milliwatts (˜80 mW). However, the efficiency increase of the power amplifier resulting from bypassing the transmit filter is about two hundred and sixty milliwatts (˜260 mW), which maps to current savings of about one hundred and eight milliwatts (˜180 mW). Thus, the increase in the power amplifier efficiency offsets the power consumption resulting from the use of the additional receive antenna and corresponding receive path. For example, the bypass mode is enabled at high Tx power where potential current savings may likely offset the incremental current consumption incurred by the additional receive antenna. It is noted that these values may change based on the application.

The digital technique may be implemented in the digital domain of the wireless transceiver architecture of a user equipment to cancel the in-device interference from the transmit section. The digital technique includes detecting or determining information corresponding to a direction of arrival of interfering signals. For example, the information may include an angle of arrival of an interfering signal. In one aspect, the digital technique includes detecting an angle of arrival of interference (e.g., in-device interference generated by the transmit section) corresponding to a dominant spatial direction. The digital technique also includes determining whether to bypass the transmit filter based on the dominant spatial direction of arrival of the interference. For example, the transmit filter is bypassed when a dominant Eigenvalue associated with the dominant spatial direction exceeds one or more remaining Eigenvalues by a threshold amount. The direction of the interference corresponds to an Eigenvector associated to the dominant (e.g., strongest) Eigenvalue. The Eigenvalue represents the strength of the interference.

In some aspects of the present disclosure, the digital technique includes calculating a spatial covariance matrix in the absence of an incoming downlink signal (e.g., a desired signal or signal of interest) and/or when an uplink signal is present in the user equipment. The digital technique further includes selecting a set of Eigenvectors computed from the spatial covariance matrix. The selected set of Eigenvectors are associated with Eigenvalues that are smaller than a dominant Eigenvalue. For example, a selected Eigenvector may be associated with a smallest Eigenvalue. The spatial covariance matrix is calculated to determine if dominant spatial directions exists by inspecting its Eigenvalues. When it is verified that dominant spatial directions exist, the spatial direction orthogonal to the interference is extracted from the Eigenvectors and used to cancel the in-device interference when it is determined that the transmit filter is to be bypassed. The covariance matrix is based on the in-device interference generated by the transmit antenna of the user equipment. In some aspects, the transmit filter is bypassed when the dominant Eigenvalue associated with the dominant spatial direction exceeds one or more remaining Eigenvalues by a threshold amount.

According to the present disclosure, a separate transmit filter may be used instead of a duplexer, which includes both the transmit filter and the receive filter. Separating the transmit filter from the receive filter(s) simplifies the design of a wireless transceiver architecture. The transmit filter is coupled to a transmit antenna and the receive filter is coupled a receive antenna. Thus, rather than using the same antenna for transmitting and receiving in conjunction with a duplexer, a transmit antenna is used in conjunction with the transmit filter along a transmit path and a receive antenna is used in conjunction with the receive filter along a receive path. This separation allows for independent control of the transmit filter and independent control of the receive filter. The independent control allows for selectively bypassing the transmit filter when favorable conditions are met, to improve the efficiency of the power amplifier by, among others, significantly reducing insertion loss.

In some aspects of the present disclosure, the techniques for bypassing the transmit filter or the interference cancellation implementation are performed in a frequency domain. For example, increased levels of receive band noise or transmit noise resulting from bypassing the transmit filter are mitigated by a spatial filter that places a spatial null in the direction of arrival of the transmit noise at a cost of enabling an additional receive antenna and its corresponding receive path (e.g., a radio frequency and baseband (RF+BB) chain). In this aspect, the spatial filtering may be implemented in frequency domain using one or more devices integrated into a single device or with at least one of the devices separate but coupled to the other devices. For example, the one or more devices for the spatial filtering may include a data processor, a combiner (e.g., linear minimum mean square error (LMMSE) combiner), a covariance device, vector decomposition device, and a vector selection device. The covariance device, the vector decomposition device, and the vector selection device may be included in the LMMSE combiner.

The extra or additional degree of freedom provided by the additional receive antenna is exploited by the LMMSE combiner to remove the transmit noise while maintaining a same performance and rank that are characteristic of a wireless transceiver architecture with an active transmit filter without the additional receive antenna.

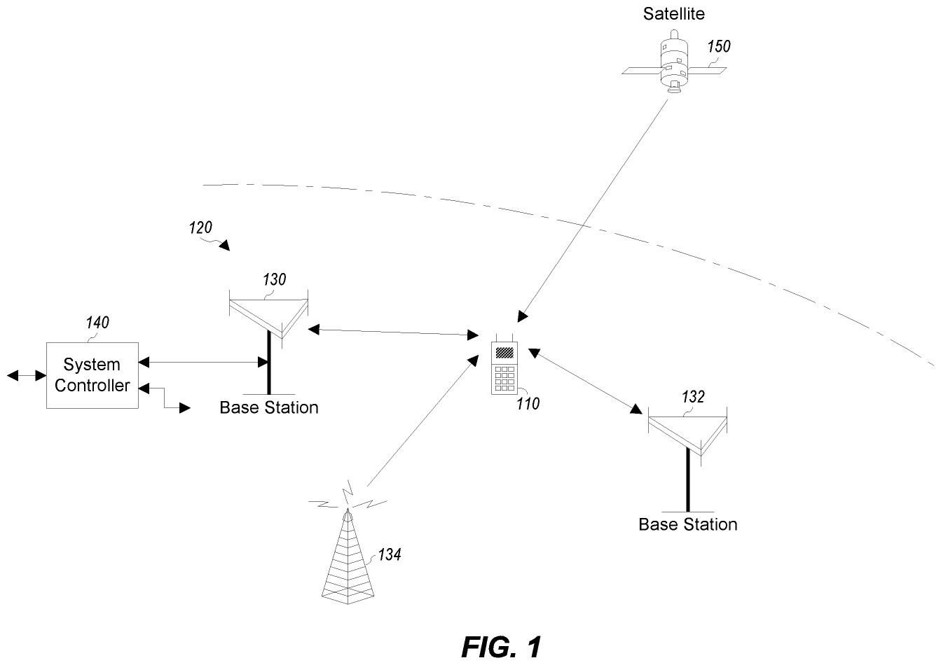

FIG. 1 shows a wireless device 110 communicating with a wireless communications system 120, according to aspects of the present disclosure. The wireless device may be configured to implement the digital techniques in time or frequency domain, according to aspects of the present disclosure. The wireless communications system 120 may be a 5G system, a long term evolution (LTE) system, a code division multiple access (CDMA) system, a global system for mobile communications (GSM) system, a wireless local area network (WLAN) system, or some other wireless system. A CDMA system may implement wideband CDMA (WCDMA), time division synchronous CDMA (TD-SCDMA), CDMA2000, or some other version of CDMA. For simplicity, FIG. 1 shows the wireless communications system 120 including two base stations 130 and 132 and one system controller 140. In general, a wireless system may include any number of base stations and any number of network entities.

A wireless device 110 may also be referred to as a user equipment (UE). The user equipment may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. The wireless device 110 may be a cellular phone, a smartphone, a tablet, a wireless modem, a personal digital assistant (PDA), a handheld device, a laptop computer, a Smartbook, a netbook, a cordless phone, a wireless local loop (WLL) station, a Bluetooth device, etc. For example, the wireless device 110 may support Bluetooth low energy (BLE)/BT (Bluetooth) with a low energy/high efficiency power amplifier having a small form factor of a low cost.

The wireless device 110 may be capable of communicating with the wireless communications system 120. The wireless device 110 may also be capable of receiving signals from broadcast stations (e.g., a broadcast station 134), signals from satellites (e.g., a satellite 150) in one or more global navigation satellite systems (GNSS), etc. The wireless device 110 may support one or more radio technologies for wireless communications such as 5G, LTE, CDMA2000, WCDMA, TD-SCDMA, GSM, 802.11, BLE/BT, etc. The wireless device 110 may also support carrier aggregation, which is operation on multiple carriers.

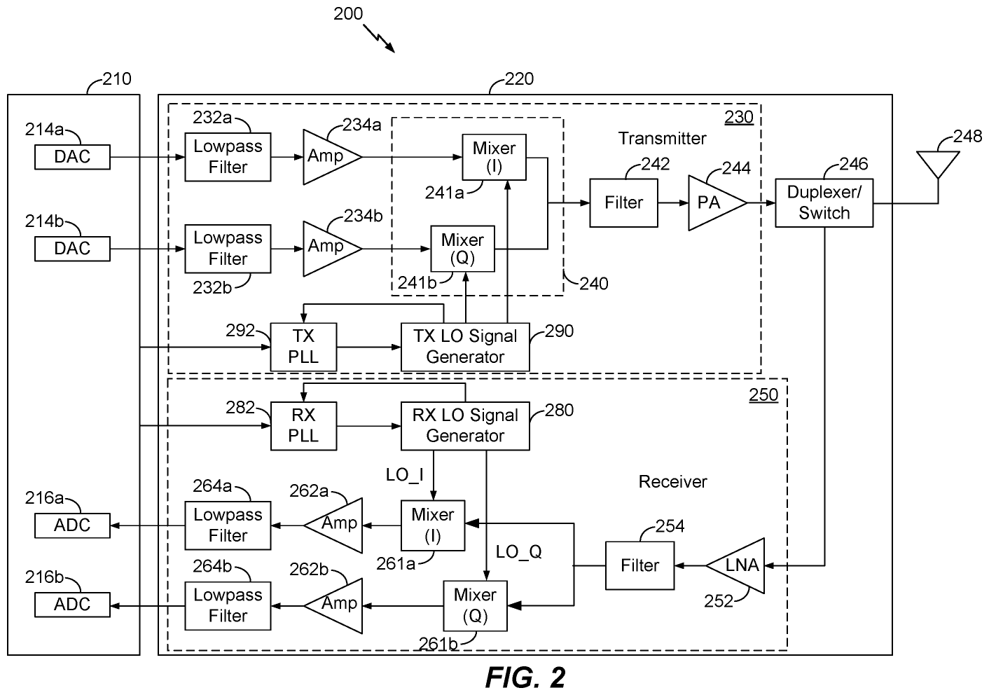

FIG. 2 shows a block diagram of an exemplary design of a wireless device 200, such as the wireless device 110 shown in FIG. 1, including a fully integrated differential hard-switching radio frequency (RF) power amplifier with harmonic rejection, according to aspects of the present disclosure. FIG. 2 shows an example of a mobile RF transceiver 220, which may be a wireless transceiver (WTR). In general, the conditioning of the signals in a transmitter 230 and a receiver 250 may be performed by one or more stages of amplifier(s), filter(s), upconverters, downconverters, and the like. These circuit blocks may be arranged differently from the configuration shown in FIG. 2. Furthermore, other circuit blocks not shown in FIG. 2 may also be used to condition the signals in the transmitter 230 and receiver 250. Unless otherwise noted, any signal in FIG. 2, or any other figure in the drawings, may be either single-ended or differential. Some circuit blocks in FIG. 2 may also be omitted.

In the example shown in FIG. 2, the wireless device 200 generally includes the mobile RF transceiver 220 and a data processor 210. The data processor 210 may include a memory (not shown) to store data and program codes, and may generally include analog and digital processing elements. The mobile RF transceiver 220 may include the transmitter 230 and receiver 250 that support bi-directional communication. In general, the wireless device 200 may include any number of transmitters and/or receivers for any number of communications systems and frequency bands. All or a portion of the mobile RF transceiver 220 may be implemented on one or more analog integrated circuits (ICs), radio frequency (RF) integrated circuits (RFICs), mixed-signal ICs, and the like.

In a transmit path, the data processor 210 processes data to be transmitted. The data processor 210 also provides in-phase (I) and quadrature (Q) analog output signals to the transmitter 230 in the transmit path. In an exemplary aspect, the data processor 210 includes digital-to-analog-converters (DACs) 214a and 214b for converting digital signals generated by the data processor 210 into the in-phase (I) and quadrature (Q) analog output signals (e.g., I and Q output currents) for further processing.

Within the transmitter 230, lowpass filters 232a and 232b filter the in-phase (I) and quadrature (Q) analog transmit signals, respectively, to remove undesired images caused by the prior digital-to-analog conversion. Amplifiers 234a and 234b (Amp) amplify the signals from lowpass filters 232a and 232b, respectively, and provide in-phase (I) and quadrature (Q) baseband signals. Upconverters 240 include an in-phase upconverter 241a and a quadrature upconverter 241b that upconverter the in-phase (I) and quadrature (Q) baseband signals with in-phase (I) and quadrature (Q) transmit (TX) local oscillator (LO) signals from a TX LO signal generator 290 to provide upconverted signals. A filter 242 filters the upconverted signals to reduce undesired images caused by the frequency upconversion as well as interference in a receive frequency band. A power amplifier (PA) 244 amplifies the signal from filter 242 to obtain the desired output power level and provides a transmit radio frequency signal. The transmit radio frequency signal is routed through a duplexer/switch 246 and transmitted via an antenna 248. The duplexer/switch 246, however, introduces insertion loss in a communication path. This follows because the duplexer is placed after the power amplifier 244 and in close proximity to the antenna 248.

In a receive path, the antenna 248 receives communication signals and provides a received radio frequency (RF) signal, which is routed through the duplexer/switch 246 and provided to a low noise amplifier (LNA) 252. The duplexer/switch 246 is designed to operate with a specific receive (RX) to transmit (TX) (RX-to-TX) duplexer frequency separation, such that RX signals are isolated from TX signals. The received RF signal is amplified by the LNA 252 and filtered by a filter 254 to obtain a desired RF input signal. Downconversion mixers 261a and 261b mix the output of the filter 254 with in-phase (I) and quadrature (Q) receive (RX) LO signals (i.e., LO_I and LO_Q) from an RX LO signal generator 280 to generate in-phase (I) and quadrature (Q) baseband signals. The in-phase (I) and quadrature (Q) baseband signals are amplified by amplifiers 262a and 262b and further filtered by lowpass filters 264a and 264b to obtain in-phase (I) and quadrature (Q) analog input signals, which are provided to the data processor 210. In the exemplary configuration shown, the data processor 210 includes analog-to-digital-converters (ADCs) 216a and 216b for converting the analog input signals into digital signals for further processing by the data processor 210.

In FIG. 2, the transmit local oscillator (TX LO) signal generator 290 generates the in-phase (I) and quadrature (Q) TX LO signals used for frequency upconversion, while a receive local oscillator (RX LO) signal generator 280 generates the in-phase (I) and quadrature (Q) RX LO signals used for frequency downconversion. Each LO signal is a periodic signal with a particular fundamental frequency. A phase locked loop (PLL) 292 receives timing information from the data processor 210 and generates a control signal used to adjust the frequency and/or phase of the TX LO signals from the TX LO signal generator 290. Similarly, a PLL 282 receives timing information from the data processor 210 and generates a control signal used to adjust the frequency and/or phase of the RX LO signals from the RX LO signal generator 280.

The wireless device 200 may support carrier aggregation and may (i) receive multiple downlink signals transmitted by one or more cells on multiple downlink carriers at different frequencies and/or (ii) transmit multiple uplink signals to one or more cells on multiple uplink carriers. For intra-band carrier aggregation, the transmissions are sent on different carriers in the same band. For inter-band carrier aggregation, the transmissions are sent on multiple carriers in different bands. Those skilled in the art will understand, however, that aspects described herein may be implemented in systems, devices, and/or architectures that do not support carrier aggregation.

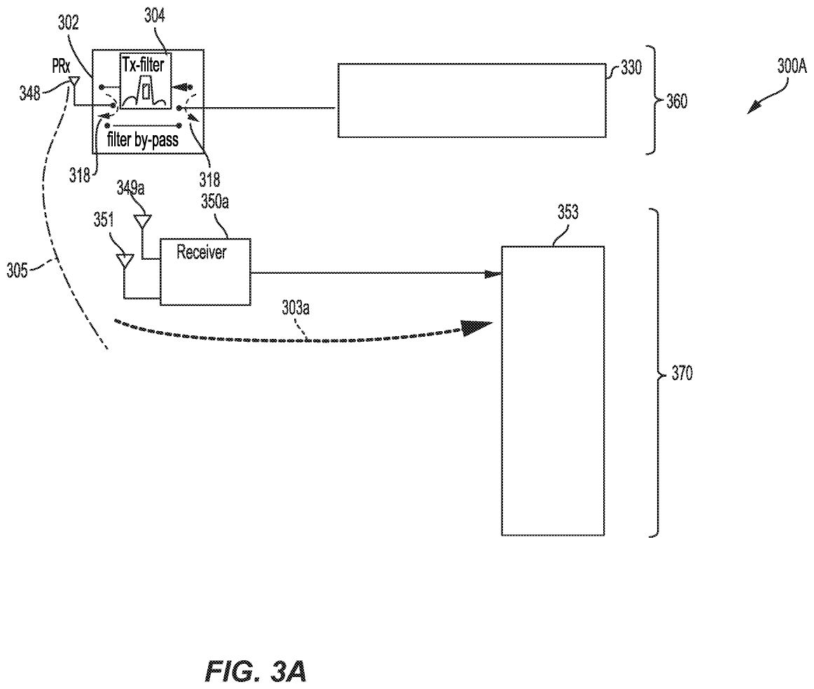

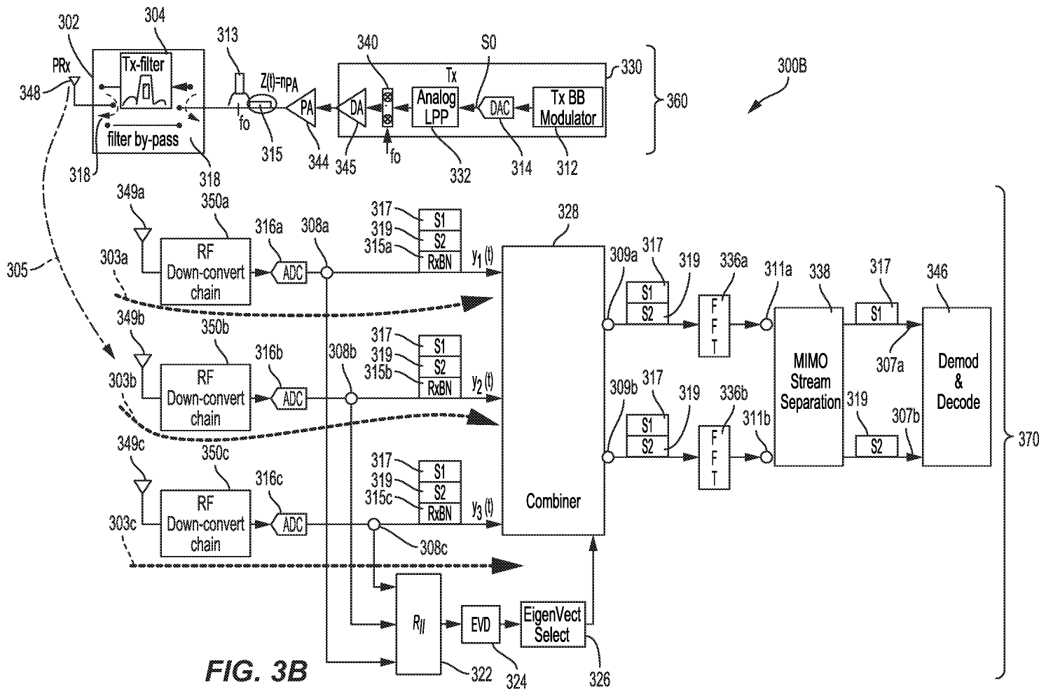

FIG. 3A illustrates a wireless transceiver architecture 300A for implementing interference cancellation, according to aspects of the present disclosure. The wireless transceiver architecture 300A includes a transmit section 360 and a receive section 370. The interference may be self-interference or in-device interference within the wireless device that travels from the transmit section 360 to the receive section 370 via a coupling channel 305. For example, the wireless transceiver architecture 300A may include a transmitter 330 that is operating as an aggressor radio (e.g., a radio that is causing interference) such that a receiver 350a that corresponds to a first radio frequency down-convert chain operate as a victim radio (e.g., a radio that receives interference from an aggressor radio).

The transmitter 330 may be coupled to a transmit antenna 348 and a filter module 302. The filter module 302 may include a transmit filter 304 (e.g., a transmit surface acoustic wave (SAW) filter, a transmit bulk acoustic wave (BAW) filter or other filters) and a bypass path 318 to selectively bypass the transmit filter 304 when the bypass mode is enabled. The bypass path 318 may include one or more bypass switches.

Referring to the receive section 370, the wireless transceiver architecture 300B may include a first receive path 303a. The first receive path 303a includes a first receive antenna 349a and an additional receive antenna 351, a first receiver 350a and a controller 353. Although only a single first receiver 350a is shown, the receiver may include multiple receivers with each receiver coupled to one or more antennas. The controller 353 may include a combiner (e.g., a spatial combiner or a linear combiner), an antenna control device or a data processor. Multiple signals from the different receivers may be combined in different ways based on spatial properties to cancel in-device interference in the receive paths. For example, the controller 353 detects a dominant spatial direction of dominant interference and determines whether to bypass a transmit filter based on energy associated with the dominant spatial direction of the interference.

FIG. 3B illustrates a wireless transceiver architecture 300B for interference cancellation, according to aspects of the present disclosure. For illustrative purposes, some of the labelling and numbering of the devices and features of FIG. 3B are similar to those of FIG. 3A. The wireless transceiver architecture 300B may be implemented in a wireless device (e.g., wireless device 200 of FIG. 2). The wireless transceiver architecture 300B may include the transmit section 360 and the receive section 370. The interference may be self-interference or in-device interference within the wireless device that travels from the transmit section 360 to the receive section 370 via the coupling channel 305. For example, the wireless transceiver architecture 300B may include the transmitter 330 that is operating as an aggressor radio (e.g., the radio that is causing an interference) such that one or more receivers 350a, 350b, and 350c that respectively correspond to the first radio frequency down-convert chain, a second radio frequency down-convert chain, and a third radio frequency down-convert chain operate as the victim radio (e.g., the radio that is interfered by an interference from an aggressor radio).

Referring to the transmit section 360, the transmitter 330 may be coupled to the transmit antenna 348, the filter module 302 and a second power amplifier stage 344. The filter module 302 may include the transmit filter 304 (e.g., a transmit surface acoustic wave (SAW) filter, a transmit bulk acoustic wave (BAW) filter or other filters) and the bypass path 318 to selectively bypass the transmit filter 304 when the bypass mode is enabled. The bypass path 318 may include one or more bypass switches. The transmitter 330 may include a transmit baseband (BB) modulator 312, a digital-to-analog converter (DAC) 314, a first filter 332 (e.g., an analog low pass filter), a mixer 340, and a first power amplifier stage 345. In some aspects, the second power amplifier stage 344 may be incorporated into the transmitter 330. The first power amplifier stage 345 may be a drive amplifier while the second power amplifier stage 344 may be a power amplifier. Other amplifier configurations are also possible.

The transmit BB modulator 312 provides digital samples that are passed to the DAC 314 where the digital samples are converted into an analog continuous time signal SO. The analog continuous time signal SO is then filtered by the first filter 332 and up-converted to a carrier frequency by the mixer 340. After amplification by the first power amplifier stage 345 and the second power amplifier stage 344, a transmit signal 313 is provided to the antenna 348 for transmission via the filter module 302. The output of the transmitter 330 and/or the output of the second power amplifier stage 344 may include transmit noise 315 that may cause the in-device interference to the receive section 370. Accordingly, the transmit noise 315 is referred to as receive band noise (RxBN). The transmit filter 304 is configured to filter out the transmit noise 315 before transmitting the transmit signal 313 via the transmit antenna 348.

Referring to the receive section 370, the wireless transceiver architecture 300B may have multiple receive paths including the first receive path 303a, a second receive path 303b, and a third receive path 303c. Although three receive paths are illustrated, the aspects of the disclosure may be implemented with a wireless transceiver architecture 300B having fewer (e.g., two) or more (e.g., four) receive paths. These receive paths may be configured in accordance with a multiple input multiple output (MIMO) configuration.

The first receive path 303a includes the first receive antenna 349a, the first receiver 350a, a first analog-to-digital converter (ADC) 316a, a first receive terminal 308a, and a combiner 328 (e.g., a spatial combiner or a linear combiner). For example, the combiner 328 may be included in the controller 353. The second receive path 303b includes a second receive antenna 349b, a second receiver 350b, a second ADC 316b, a second receive terminal 308b, and the combiner 328. The third receive path 303c includes a third receive antenna 349c, a third receiver 350c, a third ADC 316c, a third receive terminal 308c, and the combiner 328. At the combiner 328, received signals through the first receive path 303a, the second receive path 303b, and the third receive path 303c are combined. Two paths emerge from the output of the combiner 328 with each path carrying a combination of the desired signals from a base station. For example, the desired signals may be rank two downlink communication signals including a first receive signal 317 and a second receive signal 319.

The wireless transceiver architecture 300B further includes data processing devices such as a covariance estimator device 322, a vector decomposition device 324 (e.g., an Eigenvector decomposition device), a vector selection device 326 (e.g., an Eigenvector selection device), a first fast Fourier transform (FFT) logic device 336a, a second FFT logic device 336b, a multiple input multiple output (MIMO) detector 338 (e.g., MIMO stream separation device), and a demodulation and decoder device 346. In some aspects, some or all of the covariance estimator device 322, the vector decomposition device 324, the vector selection device 326, the first FFT logic device 336a, the second FFT logic device 336b, the MIMO detector 338, the combiner 328, and the demodulation and decoder device 346 may be included in a data processor (e.g., data processor 210) or the controller 353 that may be coupled to the one or more receivers 350a, 350b and 350c. In some aspects, the data processor is a modem. The data processing devices may be digital domain devices of the wireless transceiver architecture 300B.

At the receive section 370, the transmitted signals from a base station (e.g., base station 130 or 132) are received by the one or more of the first receive antenna 349a, the second receive antenna 349b, and the third receive antenna 349c and respectively provided to one or more of the first receiver 350a, the second receiver 350b, and the third receiver 350c. Each of the first receiver 350a, the second receiver 350b, and the third receiver 350c conditions (e.g., filters, amplifies, and downconverts) the received signal, digitizes the conditioned signal to generate digital samples, and further processes the digital samples to generate a corresponding received symbol stream (e.g., orthogonal frequency division multiplexing (OFDM) symbol stream).

A receive data processor (e.g., data processor 210) receives and processes N (in this case three) received symbol streams from the three receivers 350a, 350b, and 350c. Different processing techniques (e.g., quadrature phase shift keying) may be implemented at the one or more receivers to provide detected symbol streams. The receive data processor (or the demodulation and decoder device 346) demodulates, deinterleaves and decodes each detected symbol stream to recover the traffic data for the data stream. As described in further detail below, the receive data processor or the data processing devices may utilize interference cancellation to cancel the interference at the receive section 370.

Jammers may pose stringent specifications on linearity of the wireless transceiver architecture 300B. For the frequency division duplex (FDD) transceiver architecture, the strongest jammer may be represented by its own transmitted signal. The large transmit-receive power difference may commonly be handled through tight radio frequency (RF) filtering, high linearity/high power consumption RF chains, and costly calibration procedures. These solutions, however, may impact efficiency that in some aspects could even be manifested by heat emanating from the wireless device.

Aspects of the present disclosure are directed to selectively bypassing the transmit filter 304 to improve PA efficiency while mitigating a resultant noise (e.g., the transmit noise 315) from the transmit section 360 (e.g., the first power amplifier stage 345 and/or the second power amplifier stage 344).

For example, the bypassing may be in accordance with a bypass mode. In the bypass mode, a digital technique (e.g., digital baseband technique) can be implemented in a digital domain of the wireless transceiver architecture 300B to mitigate the noise interference at the receive section. For example, a digital technique (e.g., digital baseband technique) is implemented in a digital domain of the wireless transceiver architecture 300B to mitigate the noise interference during a time period when the transmit filter 304 is bypassed. The digital technique may include detecting an angle of arrival of interference corresponding to a dominant spatial direction and then determining whether to bypass the transmit filter 304 based on the dominant spatial direction of arrival of the interference. Bypassing the transmit filter 304 subjects the receive section 370 to the transmit noise 315 because the transmit noise is not filtered by the bypassed transmit filter 304.

In some aspects of the present disclosure, the digital technique includes calculating a spatial covariance matrix in the absence of an incoming downlink signal (e.g., a desired signal or signal of interest) and/or when an uplink signal is present in the user equipment. The digital technique further includes selecting a set of Eigenvectors computed from the spatial covariance matrix. The selected set of Eigenvectors are associated with Eigenvalues that are smaller than a dominant Eigenvalue. The direction of the interference corresponds to an Eigenvector associated to the dominant (e.g., strongest) Eigenvalue. The Eigenvalue represents the strength of the interference.

To cancel the transmit noise, an additional antenna (e.g., the third receive antenna 349c) is enabled and used to determine whether to bypass the transmit filter 304 and also used to cancel the transmit noise 315 in the receive section 370 when it is determined that the transmit filter 304 is to be bypassed. The additional antenna may be enabled in response to enabling a bypass mode where a transmit filter can be selectively bypassed based on the operating condition.

One or more antennas (e.g., the third receive antenna 349c) in the receive section 370 of the wireless transceiver architecture 300B may be available when only some of the available antennas of the wireless transceiver architecture 300B are used simultaneously. This available receive antenna 349c and its corresponding receive path (e.g., the third receive path 303c) is selectively used to opportunistically determine whether interference from the transmit section 360 has a spatial structure that can be exploited to cancel the interference from the transmit section 360. The addition of the third receive antenna 349c and the corresponding third receive path 303c provides an additional degree of freedom. This additional degree of freedom is useful to perform spatial combining with antennas that are currently used for communication in order to cancel the in-device interference from the transmit section 360.

When the transmit filter 304 is turned on, less transmit noise 315 reaches the receive section 370. However, when the transmit filter 304 is bypassed, more transmit noise 315 reaches the receive section 370. For example, desired signals (e.g., the first receive signal 317 and the second receive signal 319) transmitted from a base station (e.g., the base station 130 or 132 of FIG. 1) as well as the transmit noise 315 are received by the receive section 370. The desired signals and the transmit noise 315 are received by the first receive antenna 349a and the second receive antenna 349b and their respective first and second receive paths 303a and 303b. The desired signals and the transmit noise 315 are also received by the additional third receive antenna 349c and its corresponding third receive path 303c when the bypass mode is enabled. In some aspects, the desired signals may be a rank two downlink communication. The transmit noise 315 in this case is receive band noise (RxBN) that is problematic because it is operating at a same in-band frequency as the desired signals and hence cannot be filtered at the receiver(s).

In one aspect of the disclosure, the first receive signal 317, the second receive signal 319, and the transmit noise 315 are mapped as a first column vector y of three elements as follows:

[y1(t)]

[y2(t)]

[y3(t)]

Each of the variables y1(t), y2(t), and y3(t) are time domain representations of the combination of the desired signals (e.g., the first receive signal 317 and the second receive signal 319) and the transmit noise 315. The variables y1(t), y2(t), and y3(t) are provided to the combiner 328 through each of their respective receive paths 303a, 303b, and 303c and to the covariance estimator device 322 to determine the covariant matrix. A matrix operation in the combiner 328 may include multiplying the first matrix y with a second matrix that includes the selected eigenvectors. The transmit noise may be represented in the first receive path 303a as first transmit noise 315a, in the second receive path 303b as second transmit noise 315b, and in the third receive path 303c as third transmit noise 315c.

The second vector is based on the calculated covariance matrix and represents a direction orthogonal to the interference. The second vector is multiplied with the first vector to cancel the transmit noise 315 such that one or more outputs of the combiner 328 include the first receive signal 317 and the second receive signal 319 without the transmit noise 315. For example, each of a first output 309a of the combiner 328 and a second output 309b of the combiner 328 only include a combination of the first receive signal 317 and the second receive signal 319.

The second vector may be determined using the covariance estimator device 322, the vector decomposition device 324, and the vector selection device 326. The covariance estimator device 322, the vector decomposition device 324, and the vector selection device 326 may be configured to operate in a digital domain. To determine the second vector, samples of the transmit noise 315 from each of the first receive path 303a, the second receive path 303b, and the third receive path 303c are provided to the covariance estimator device 322. In some aspects, the digital technique (including the determination of the second vector) occurs in the absence of an incoming downlink signal (e.g., a desired signal or signal of interest) and/or when an uplink signal is present in the user equipment. The digital technique is implemented in the absence of an incoming downlink signal to specifically determine a direction of the self-interference independent of other sources or signals in order to determine whether to bypass the transmit filter.

The digital technique can be implemented in a digital domain of the wireless transceiver architecture to mitigate the interference at the receive section. The digital technique includes detecting an angle of arrival of interference (e.g., in-device interference generated by the transmit section) corresponding to a dominant spatial direction. The digital technique also includes determining whether to bypass the transmit filter based on the dominant spatial direction of arrival of the interference.

For example, the interference (e.g., transmit noise) from the transmit section 360 to the receive section 370 travels through the coupling channel 305 and is represented by a vector h₁. This follows because each of the receivers 350a, 350b, and 350c have a spatial dimension relevant to the spatial signature/characteristic of the interference. Accordingly, the vector hi in this case is a three column by one row (3×1) vector. Assuming there are no desired signals (e.g., signal of interest (SOI)=0). The first vector y is represented as follows:

$$\underline{y} = {[ \begin{matrix}{y}_{1} ( n ) \\ {y}_{2} ( n ) \\ {y}_{3} ( n )\end{matrix} ]}_{SoI = 0} = {\underline{h}}_{I} \cdot z ( n ) + {\underline{n}}_{w} , \qquad ( 1 )$$

where y₁(n) is a first variable, which is a time domain representation of the transmit noise without a desired signal in the first receive path 303a;

y₂(n) is a second variable, which is a time domain representation of the transmit noise without a desired signal in the second receive path 303b;

y₃(n) is a third variable, which is a time domain representation of the transmit noise without a desired signal in the third receive path 303c;

z(n) is a time domain representation of the entire interference;

h₁ is a vector representation of a direction of arrival of the interference, which in this case is a three by one column vector having a single column with three elements; and

n_{w} represents thermal noise or white noise.

To extract information including a spatial signature of the interference from EQUATION 1, a vector implementation (e.g., Eigenvector implementation) is performed at the covariance estimator device 322 to determine a covariance matrix Ryy (e.g., a spatial covariance matrix) of the interference. For example, the interference information may be tapped at the terminals 308a, 308b, and 308c and provided to the covariance estimator device 322 where the covariance matrix Ryy (or specifically R_{II} assuming there are no desired signals) is determined or calculated. The covariance matrix may be calculated over a specified number (e.g., 100) of digital samples of the first variable y1(n), the second variable y2(n), and the third variable y3(n). The covariance matrix is determined to identify a direction of arrival of the interference because the direction of arrival is correlated across the first receive antenna 349a, the second receive antenna 349b, and the third receive antenna 349c.

In an aspect, the covariance matrix is determined by calculating or performing a dot product implementation between the first variable, the second variable, and the third variable. For example, the dot product is obtained by multiplying one hundred digital samples of the first variable y₁(n) with one hundred digital samples of the second variable y₂(n) and with one hundred digital samples of the third variable y₃(n). In addition, one hundred digital samples of the second variable y₂(n) are multiplied with one hundred digital samples of the first variable y₁(n) and with one hundred digital samples of the third variable y₃(n). Further, one hundred digital samples of the third variable y₃(n) are multiplied with one hundred digital samples of the first variable y₁(n) and with one hundred digital samples of the second variable y₂(n). In this case, the resulting covariance matrix is a three by three (3×3) matrix that is represented as follows:

R_{y}=R_{II}=y·y^{H}=σ_{z}²·h_{I}h_{I}^{H}=Σₘλₘvₘ·vₘ^{H},

where y·y^{H} represents the outer product of the variables;

σ_{z}² represents power of interfering signals;

h_{I} is a complex vector representation of the direction of arrival of the interference, which in this case is a three by one column vector having a single column with three elements;

h_{I}^{H} represents a transpose of the complex vector representation h_{I};

m represents a number of receive antennas (in this case three);

λₘ represents Eigenvalues;

vₘ represents Eigenvectors; and

vₘ^{H} represents a transpose conjugate of the Eigenvector representation vₘ.

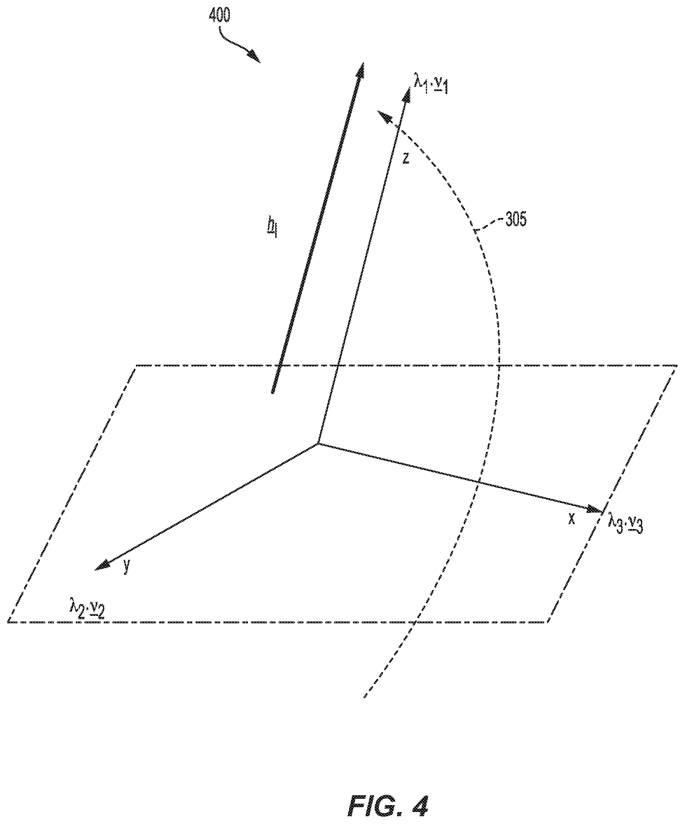

The Eigenvectors vₘ and the Eigenvalues λₘ represent the direction and energy, respectively, of the interference and are computed in the vector decomposition device 324 based on the covariance matrix R_{II}. A direction of arrival of the interference from the transmit section 360 via the coupling channel 305 can be estimated based on the calculation at the vector decomposition device 324 based on information extracted from the covariance matrix R_{II}. An exemplary illustration of the direction of arrival of the most dominant interference is shown in FIG. 4.

The Eigenvectors represent directions of arrival of the interference while the Eigenvalues represents intensity of the interference in the different directions. One of the Eigenvalues of the three Eigenvalues is a dominant Eigenvalue and the Eigenvector associated with the dominant Eigenvalue corresponds to the vector h_{I} that represents the coupling channel 305. Thus, the dominant interference is channeled through the direction represented by the vector associated with the dominant Eigenvalue. The remaining two vectors are orthogonal to the vector associated with the dominant interference. The remaining two vectors are selected by the vector selection device 326 and provided to the combiner 328. The remaining two vectors form the second matrix, which when multiplied with the first vector in the combiner 328 cancel the transmit noise 315 that is represented in the first receive path 303a as first transmit noise 315a, in the second receive path 303b as second transmit noise 315b, and in the third receive path 303c as third transmit noise 315c.

The first output 309a of the combiner 328 and the second output 309b of the combiner 328 are respectively provided to the first FFT logic device 336a and the second FFT logic device 336b. Each of the first FFT logic device 336a and the second FFT logic device 336b sample the first receive signal 317 and the second receive signal 319 over a period of time and divide the combination of the signals into their frequency components. The frequency components of the first FFT logic device 336a and the second FFT logic device 336b are respectively provided to a first input 311a and a second input 311b of the MIMO detector 338. The MIMO detector 338 decouples the first receive signal 317 from the second receive signal 319 and provides the first receive signal 317 to a first input 307a of the demodulation and decoder device 346 and the second receive signal 319 to a second input 307b of the demodulation and decoder device 346. The demodulation and decoder device 346 then demodulates and decodes bits of each of the first receive signal 317 and the second receive signal 319.

FIG. 4 is a graph 400 illustrating spatial direction of Eigenvectors computed from a spatial covariance matrix based on interference from a transmit section of a user equipment according to aspects of the present disclosure. The graph 400 shows three Eigenvectors and their corresponding Eigenvalues. The three Eigenvectors represent three different spatial directions. Each of the spatial directions is orthogonal with respect to the other two spatial directions. Each of the Eigenvalues represent an energy of the interference in the respective direction of arrival.

For example, an Eigenvalue λ₁ represents an energy of the interference in a direction (e.g., along the z-axis) represented by the Eigenvector v₁. An Eigenvalue λ₂ represents an energy of the interference in a direction (e.g., along the y-axis) represented by the Eigenvector v₂. An Eigenvalue λ₃ represents an energy of the interference in a direction (e.g., along the x-axis) represented by the Eigenvector v₃. One of the Eigenvalues of the three Eigenvalues is a dominant Eigenvalue and the Eigenvector associated with the dominant Eigenvalue is the direction of arrival of the interference. In this case, the eigenvector v₁ associated to the dominant Eigenvalue λ₁ corresponds to the vector h_{I} that represents the coupling channel 305 through which the dominant interference traverses. With the direction of arrival of the interference known, the Eigenvectors with non-dominant Eigenvalues are selected for the second matrix. These selected Eigenvectors are orthogonal to the interference represented in the first vector such that a product of the first vector and the second matrix is zero. This calculation essentially cancels out the interference.

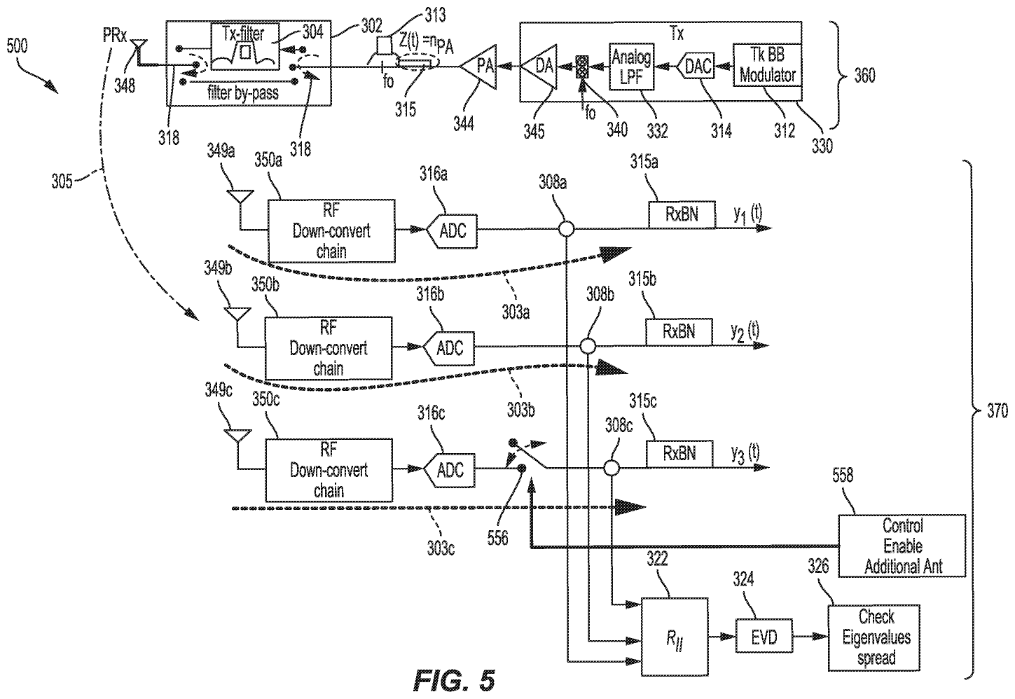

FIG. 5 illustrates a wireless transceiver architecture 500 for interference cancellation, according to aspects of the present disclosure. For illustrative purposes, some of the labelling and numbering of the devices and features of FIG. 5 are similar to those of FIG. 3B. However, the interference cancellation illustration of FIG. 5 further shows that the third receive path 303c including the third receive antenna 349c is used selectively to add another degree of freedom for the wireless transceiver architecture 500 when the transmit filter 304 is bypassed. For example, the wireless transceiver architecture 500 further includes a receive path switch 556 to selectively enable the third receive antenna 349c and its corresponding third receive path 303c. Control for the receive path switch 556 may be provided by an antenna control device 558. For example, when the bypass mode is enabled, the antenna control device 558 generates a control signal that causes the receive path switch 556 to close to enable the third receive antenna 349c. Similarly, the antenna control device 558 generates a control signal that causes the receive path switch 556 to open to disable the third receive antenna 349c when the bypass mode is disabled.

In one aspect of the disclosure, the antenna control device 558 may enable the additional antenna (e.g., the third receive antenna 349c) to receive a signal used to calculate the covariance matrix in the covariance estimator device 322 when no downlink signal (e.g., the desired signal 313) is present in the wireless transceiver architecture 500. For example, the signal received may include transmit noise illustrated across the three receive paths 303a, 303b, and 303c as first transmit noise 315a, second transmit noise 315b, and third transmit noise 315c. Thus, in this aspect, the calculation of the covariance matrix is based only on the transmit noise 315 and not the desired signal 313. In some aspects, the antenna control device 558 may enable the third receive antenna 349c to receive a signal used to calculate the covariance matrix in the covariance estimator device 322 when an uplink signal is present in the wireless transceiver architecture 500.

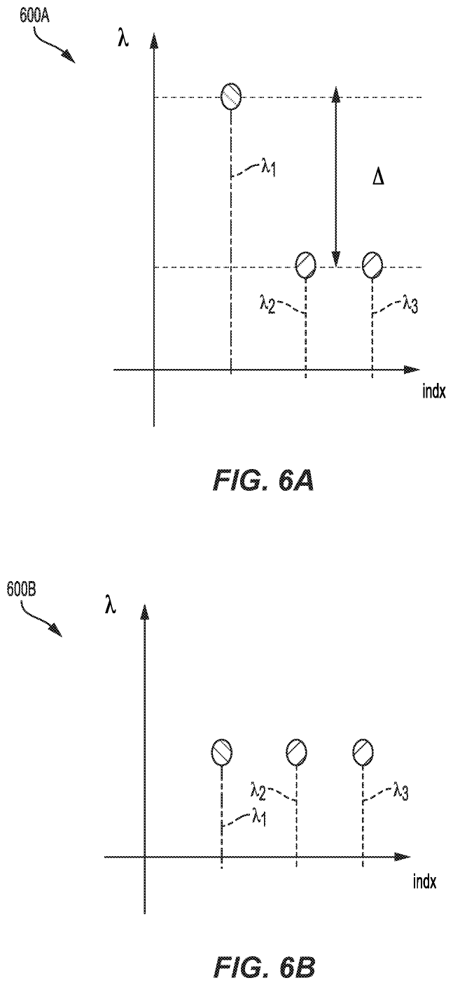

FIGS. 6A and 6B each illustrate a graph 600A and 600B, respectively, of Eigenvalues associated with different spatial directions that correspond to potential direction of arrival of in-device interference, in accordance with aspects of the present disclosure. For example, a y-axis of the graph represents the Eigenvalues λₘ that correspond to a strength of the in-device interference and the x-axis of the graph represents an index (e.g., {1,2,3}) of the Eigenvalues. Determining whether to bypass the transmit filter 304 is based on examining the eigenvalues associated to the covariance matrix to see if a dominant eigenvalue λₘ is present that would indicate a dominant spatial direction. In one aspect of the disclosure, the transmit filter 304 is bypassed when a dominant Eigenvalue associated with the dominant spatial direction exceeds one or more remaining Eigenvalues by a threshold amount. Otherwise, the transmit filter is not bypassed.

Referring to FIG. 6A, the graph 600A includes a first Eigenvalue λ₁, a second Eigenvalue λ₂, and a third Eigenvalue λ₃. In this case, the transmit filter 304 is bypassed because the dominant first Eigenvalue λ₁ exceeds each of the non-dominant second Eigenvalue λ₂ and the non-dominant third Eigenvalue λ₃ by a threshold amount Δ.

Referring to FIG. 6B, the graph 600B includes the first Eigenvalue λ₁, the second Eigenvalue λ₂, and the third Eigenvalue λ₃. In this case, the transmit filter 304 is not bypassed because of the absence of a dominant Eigenvalue. For example, the first Eigenvalue λ₁ is essentially the same value as each of the second Eigenvalue λ₂, and the third Eigenvalue λ₃. The lack of a dominant Eigenvalue may be due to the fact that the transmit noise may be dominated by white noise or thermal noise.

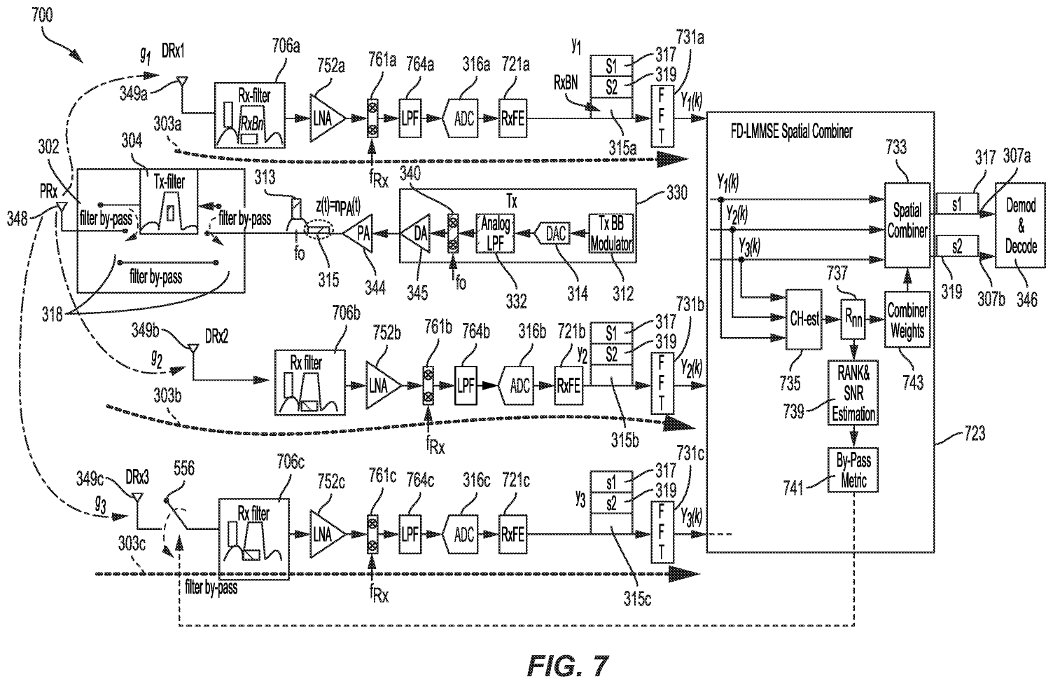

The bypass mode is enabled for different reasons. For example, the bypass mode can be enabled based on a favorable Eigen structure of the receive band noise interference that results from bypassing the Tx filter. Potential current savings can also be taken into consideration to enable Tx filter bypass. For example, the bypass mode is enabled at high Tx power where potential current savings may likely offset the incremental current consumption incurred by the additional receive antenna. In the implementation of FIG. 5, an antenna control device (e.g., the antenna control device 558) may provide control signals to selectively enable an additional receive antenna based on whether the bypass mode is enabled. For example, the antenna control device 558 generates the control signal that causes the receive path switch 556 to close to enable the third receive antenna 349c or open to disable the third receive antenna 349c. Enabling or disabling the third receive antenna 349c may be based on whether the bypass mode is enabled. A spatial filter may be used for placing a spatial null in the direction of arrival of the transmit noise 315 at the cost of enabling an additional receive antenna and its corresponding receive path. The spatial filter may be implemented in a linear minimum mean square error (LMMSE) combiner, as illustrated in FIG. 7.

FIG. 7 illustrates a wireless transceiver architecture 700 for interference cancellation in a frequency domain, according to aspects of the present disclosure. For illustrative purposes, some of the labelling and numbering of the devices and features of FIG. 7 are similar to those of FIG. 3B and FIG. 5. FIG. 7 illustrates the spatial filter for placing a spatial null in the direction of arrival of the transmit noise 315 at the cost of enabling an additional receive antenna and its corresponding receive path. The spatial filter may be implemented in a linear minimum mean square error (LMMSE) combiner 723. In this aspect, the implementation of the spatial filter is in a frequency domain.

The wireless transceiver architecture 700 illustrates the devices included in a receiver such as the first receiver 350a, the second receiver 350b, and the third receiver 350c, illustrated in FIG. 3B. For example, a first receiver (e.g., the first receiver 350a of FIGS. 3A and 3B) includes a first receive filter 706a (e.g., SAW filter), a first low noise amplifier (LNA) 752a, a first mixer 761a, and a first low pass filter 764a. The first ADC 316a of the first receive path 303a is coupled between the first low pass filter 764a and a first receive front end 721a. A second receiver (e.g., the second receiver 350b of FIG. 3B) includes a second receive filter 706b, a second low noise amplifier (LNA) 752b, a second mixer 761b, and a second low pass filter 764b. The second ADC 316b of the second receive path 303b is coupled between the second low pass filter 764b and a second receive front end 721b. A third receiver (e.g., the third receiver 350c of FIG. 3B) includes a third receive filter 706c, a third low noise amplifier (LNA) 752c, a third mixer 761c, and a third low pass filter 764c. The third ADC 316c of the third receive path 303c is coupled between the third low pass filter 764c and a third receive front end 721c.

The first receiver 350a, the second receiver 350b, and the third receiver 350c process the signal of interest (e.g., the first receive signal 317 and the second receive signal 319) and its interference component (e.g., the first transmit noise 315a, the second transmit noise 315b, and the third transmit noise 315c).

The signal of interest and its interference component is filtered by the filter (e.g., the first SAW filter 706a, the second SAW filter 706b, and the third SAW filter 706c). Because the noise component is in-band, the filter cannot filter out the noise component. The filtered signal of interest and its interference component is then amplified by an LNA (e.g., the first LNA 752a, the second LNA 752b, and the third LNA 752c). A radio frequency (RF) downconverter (e.g., the first mixer 761a, the second mixer 761b, and the third mixer 761c) downconverts the filtered and amplified signal of interest and its interference component from an RF frequency band (e.g., a receive carrier frequency) down to a baseband. An analog low pass filter (e.g., the first low pass filter 764a, the second low pass filter 764b, and the third low pass filter 764c) filters, and otherwise conditions the baseband signal from the RF downconverter and outputs an analog baseband receive signal of the signal of interest and its interference component.

An ADC (e.g., the first ADC 316a, the second ADC 316b, and the third ADC 316c) digitizes the analog baseband receive signal from the analog low pass filter to a digital baseband signal. The digital baseband signal from the ADC is then provided to the receive front end (e.g., the first receive front end 721a, the second receive front end 721b, and the third receive front end 721c) where the digital baseband signal from the ADC is conditioned. The receive front end applies digital filtering to remove thermal noise. The signal of interest and its interference component that traverse the first receive path 303a, the second receive path 303b, and the third receive path 303c may be an OFDM symbol stream. An FFT device (e.g., a first FFT logic device 731a, a second FFT logic device 731b, and a third FFT logic device 731c) converts the digital baseband signal (e.g., y₁, y₂ and y₃) from the time-domain to the frequency domain (e.g., Y₁(k), Y₂(k), and Y₃(k)).

The LMMSE combiner 723 includes a channel estimator 735, a covariance device 737, a rank and signal-to-noise ratio estimation device 739, an antenna control device 741, a spatial combiner 733, and a weight function device 743. Similar to the antenna control device 558, the antenna control device 741 generates a control signal that causes the receive path switch 556 to close to enable the third receive antenna 349c or open to disable the third receive antenna 349c. Enabling or disabling the third receive antenna 349c may be based on whether the bypass mode is enabled. Similar to the covariance estimator device 322, the covariance device 737 is used to calculate the covariance matrix that is subsequently used to determine whether to bypass the transmit filter 304 or used to determine vectors for the second matrix. The covariant matrix calculation may also occur when no downlink signal (e.g., the desired signal 313) is present in the wireless transceiver architecture 700.

Similar to the combiner 328, the spatial combiner 733, receives signals (albeit frequency domain signals (Y₁(k), Y₂(k), and Y₃(k)) via the first receive path 303a, the second receive path 303b, and the third receive path 303c. The frequency domain signals are combined with vectors based on the covariant matrix to cancel the in-device interference. The first receive signal 317 is decoupled from the second receive signal 319 in the LMMSE combiner 723. The decoupled first receive signal 317 and second receive signal 319 are respectively provided to the first input 307a of the demodulation and decoder device 346 and the second input 307b of the demodulation and decoder device 346. The demodulation and decoder device 346 then demodulates and decodes bits of each of the first receive signal 317 and the second receive signal 319. The channel estimator 735, the weight function device 743 and the rank and signal-to-noise ratio estimation device 739 are part of the LMMSE combiner 723 and may operate to estimate the coefficients (weights) of the combiner 723.

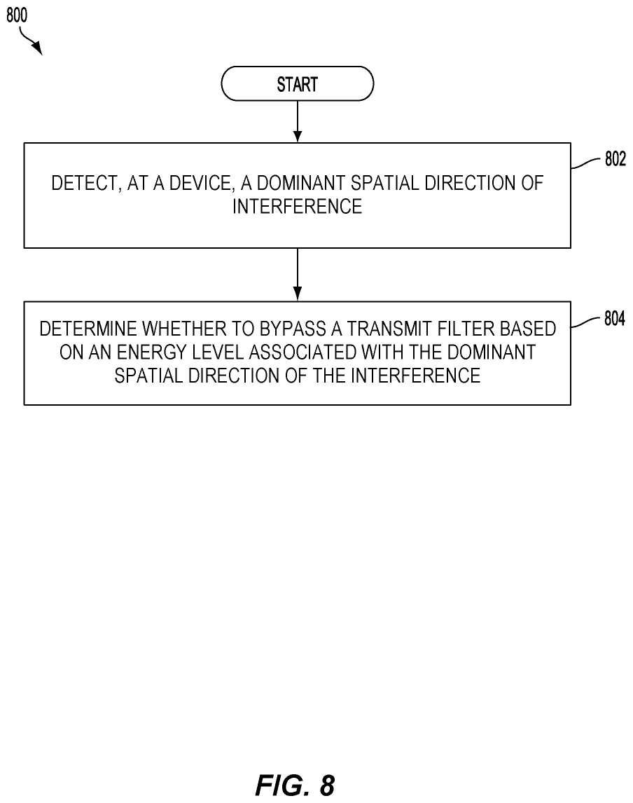

FIG. 8 illustrates a method 800 of wireless communication according to aspects of the present disclosure. The blocks in the method 800 can be performed in or out of the order shown, and in some aspects, can be performed at least in part in parallel. The method may be implemented in a user equipment. At block 802, a dominant spatial direction of interference is detected at a user equipment. At block 804, it is determined whether to bypass a transmit filter based on an energy level associated with the dominant spatial direction of the interference.

According to a further aspect of the present disclosure, a wireless transceiver architecture is described. The wireless transceiver architecture includes means for detecting, at a device, a dominant spatial direction of interference and means for determining whether to bypass a transmit filter based on an energy level associated with the dominant spatial direction of the interference. The means for detecting and the means for determining, for example, include the control device 558, as shown in FIG. 5, the antenna control device 741, as shown in FIG. 7, the data processor 210 and the LMMSE combiner 723. In another aspect, the aforementioned means may be any module, or any apparatus configured to perform the functions recited by the aforementioned means.

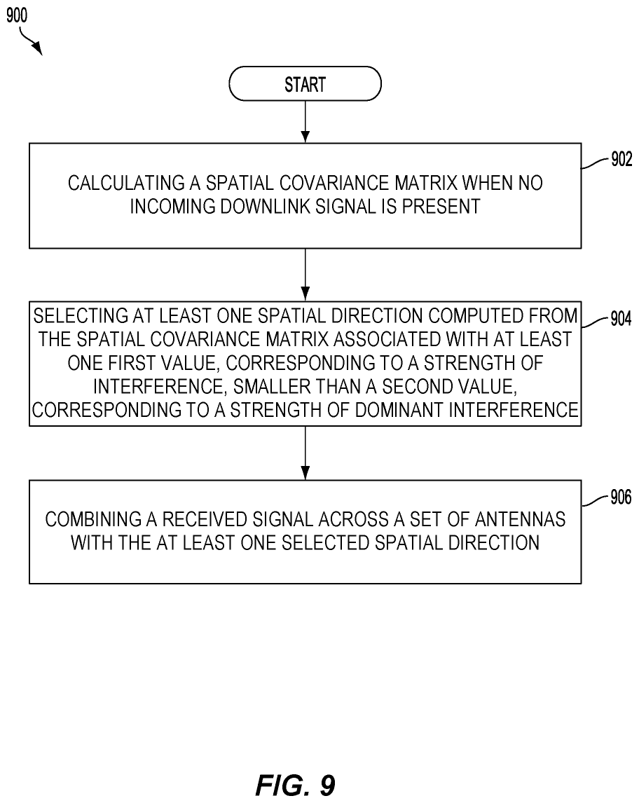

FIG. 9 illustrates an interference cancellation method 900 according to aspects of the present disclosure. The blocks in the method 900 can be performed in or out of the order shown, and in some aspects, can be performed at least in part in parallel. The method may be implemented in a user equipment. At block 902, a spatial covariance matrix is calculated when no incoming downlink (DL) signal is present. At block 904, one or more spatial directions is computed from the spatial covariance matrix associated with one or more first values corresponding to strength of interference smaller than a second value corresponding to strength of dominant interference. At block 906, a received signal across a set of antennas with the one or more selected spatial directions are combined.

According to a further aspect of the present disclosure, an interference device is described. The interference cancellation device includes means for calculating a spatial covariance matrix when no incoming downlink signal is present, means for selecting at least one spatial direction computed from the spatial covariance matrix and means for combining a received signal across a set of receive antennas of the device with the one or more selected spatial direction. The means for calculating, selecting and/or combining, for example, include the control device 558, as shown in FIG. 5, the antenna control device 741, as shown in FIG. 7, the data processor 210, as shown in FIG. 2, the covariance estimator device 322, as shown in FIG. 3B, the vector decomposition device 324, as shown in FIG. 3B, the vector selection device 326, as shown in FIG. 3B, the combiner 328, as shown in FIG. 3B, and the LMMSE combiner 723, as shown in FIG. 7. In another aspect, the aforementioned means may be any module, or any apparatus configured to perform the functions recited by the aforementioned means.

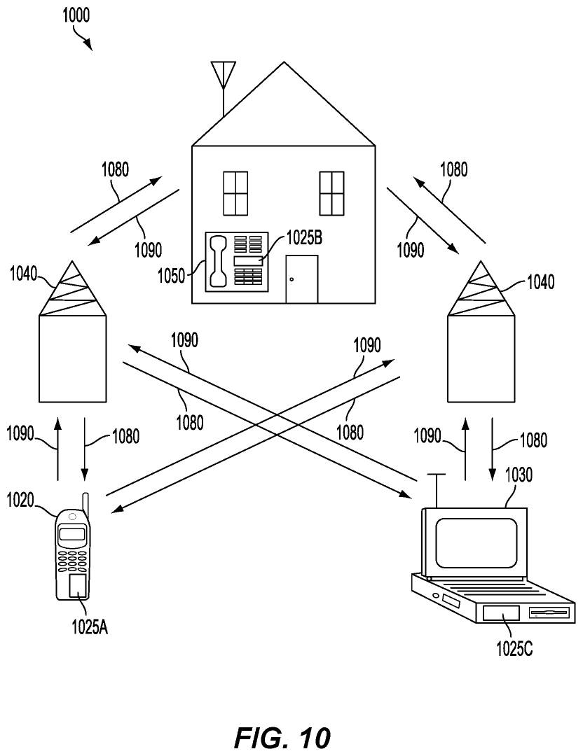

FIG. 10 is a block diagram showing an exemplary wireless communications system 1000 in which an aspect of the disclosure may be advantageously employed. For purposes of illustration, FIG. 10 shows three remote units 1020, 1030, and 1050 and two base stations 1040. It will be recognized that wireless communications systems may have many more remote units and base stations. Remote units 1020, 1030, and 1050 include IC devices 1025A, 1025C, and 1025B that include the disclosed wireless transceiver architecture. It will be recognized that other devices may also include the disclosed wireless transceiver architecture, such as the base stations, user equipment, and network equipment. FIG. 10 shows forward link signals 1080 from the base station 1040 to the remote units 1020, 1030, and 1050 and reverse link signals 1090 from the remote units 1020, 1030, and 1050 to base station 1040.

In FIG. 10, remote unit 1020 is shown as a mobile telephone, remote unit 1030 is shown as a portable computer, and remote unit 1050 is shown as a fixed location remote unit in a wireless local loop system. For example, a remote units may be a mobile phone, a hand-held personal communications systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 10 illustrates remote units according to the aspects of the disclosure, the disclosure is not limited to these exemplary illustrated units. Aspects of the disclosure may be suitably employed in many devices, which include the disclosed wireless transceiver architecture.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communications networks and/or communications technologies. The apparatuses, methods, and systems disclosed herein may also be implemented digitally and differentially, among others. The various components illustrated in the figures may be implemented as, for example, but not limited to, software and/or firmware on a processor, ASIC/FPGA/DSP, or dedicated hardware. In addition, the features and attributes of the specific example aspects disclosed above may be combined in different ways to form additional aspects, all of which fall within the scope of the present disclosure.

The foregoing method descriptions and the process flow diagrams are provided merely as illustrative examples and are not intended to require or imply that the operations of the method must be performed in the order presented. Certain of the operations may be performed in various orders. Words such as “thereafter,” “then,” “next,” etc., are not intended to limit the order of the operations; these words are simply used to guide the reader through the description of the methods.

The various illustrative logical blocks, modules, circuits, and operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the various aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example aspects and applications, other aspects that are apparent to t hose of ordinary skill in the art, including aspects, which do not provide all of the features and advantages set forth herein, are also within the scope of this disclosure. For example, the apparatuses, methods, and systems described herein may be performed digitally and differentially, among others. Accordingly, the scope of the present disclosure is intended to be defined only by reference to the appended claims.

1. A method of wireless communication, comprising:
detecting, at a device, a dominant spatial direction of in-device interference; and
determining whether to bypass a transmit filter of the device based on an energy level associated with the dominant spatial direction of in-device interference, in which the transmit filter is selectively coupled to a transmit antenna of the device to filter a frequency range of radio frequency signals to be sent via the transmit antenna.

2. The method of claim 1, wherein the in-device interference includes in-device interference generated by the transmit antenna of the device.

3. The method of claim 1, further comprising:
bypassing the transmit filter; and
reducing the in-device interference generated by the transmit antenna of the device in response to the bypassing based on enabling an additional receive circuit of the device and the dominant spatial direction of the in-device interference.

4. The method of claim 1, further comprising:
bypassing the transmit filter; and
reducing the in-device interference generated by the transmit antenna of the device in response to the bypassing by combining received signals across a set of receive antennas of the device.

5. The method of claim 4, wherein the combining comprises combining the received signals based on spatial information including the dominant spatial direction of the in-device interference to cancel at least a portion of the in-device interference.

6. The method of claim 1, further comprising:
bypassing the transmit filter; and
identifying interference to be cancelled in response to bypassing the transmit filter based at least in part on signals received via an additional receive antenna.

7. The method of claim 1, further comprising reducing the in-device interference in response to bypassing the transmit filter based at least in part on combining a plurality of signals, each of the plurality of signals received by a different one of a set of receive antennas based at least in part on spatial properties of the plurality of signals.

8. The method of claim 1, wherein determining whether to bypass the transmit filter comprises determining to bypass the transmit filter when a dominant Eigenvalue associated with the dominant spatial direction of the in-device interference exceeds at least one other Eigenvalue by a threshold amount, the dominant spatial direction of the in-device interference corresponding to an Eigenvector associated with the dominant Eigenvalue.

9. The method of claim 1, wherein determining whether to bypass the transmit filter comprises determining to bypass the transmit filter when the dominant spatial direction of the in-device interference is detected.

10. The method of claim 1, wherein determining whether to bypass the transmit filter is further based on when a transmit power for transmission by the device is above a threshold.

11. The method of claim 1, wherein detecting the dominant spatial direction of the in-device interference further comprises:
bypassing the transmit filter during a first period;
activating a plurality of receive antennas during the first period;
determining information corresponding to a direction of arrival of interfering signals having different energy at each of the plurality of receive antennas; and
determining the dominant spatial direction of the in-device interference based on the information.

12. The method of claim 1, wherein detecting the dominant spatial direction of the in-device interference comprises:
bypassing the transmit filter;
calculating, in response to bypassing the transmit filter, a spatial covariance matrix when no incoming downlink signal is present;
selecting, in response to bypassing the transmit filter, at least one spatial direction computed from the spatial covariance matrix associated with at least one first value corresponding to strength of in-device interference smaller than a second value corresponding to strength of dominant in-device interference; and
combining, in response to bypassing the transmit filter, a received signal across a set of receive antennas of the device with the at least one selected spatial direction.

13. The method of claim 12, in which calculating the spatial covariance matrix comprises calculating the spatial covariance matrix based on the in-device interference generated by the transmit antenna of the device in response to the transmit filter being bypassed.

14. The method of claim 12, wherein the calculating occurs when an uplink signal is present in the device.

15. An apparatus for wireless communication, comprising:
a memory;
a transceiver configured for wireless communication;
a transmit filter of the transceiver; and
at least one processor coupled to the memory and the transceiver, the at least one processor configured:
to detect, a dominant spatial direction of in-device interference; and
to determine whether to bypass the transmit filter based on an energy level associated with the dominant spatial direction of the in-device interference, in which the transmit filter is selectively coupled to a transmit antenna of the apparatus to filter a frequency range of radio frequency signals to be sent via the transmit antenna.

16. The apparatus of claim 15, wherein the in-device interference includes in-device interference generated by the transmit antenna.

17. The apparatus of claim 15, wherein the at least one processor is further configured to bypass the transmit filter when a dominant Eigenvalue associated with the dominant spatial direction of the in-device interference exceeds at least one remaining Eigenvalue by a threshold amount, the dominant spatial direction of the in-device interference corresponding to an Eigenvector associated with the dominant Eigenvalue.

18. The apparatus of claim 15, wherein the at least one processor is further configured to bypass the transmit filter when the dominant spatial direction of the in-device interference is detected.

19. The apparatus of claim 15, wherein the at least one processor is configured to bypass the transmit filter when a transmit power for transmission by the device is above a threshold.

20. A method of wireless communication, comprising:
calculating a spatial covariance matrix at a device when no desired incoming downlink signal from another device is present;
selecting at least one spatial direction, computed from the spatial covariance matrix, associated with at least one first value corresponding to strength of in-device interference smaller than a second value corresponding to strength of dominant in-device interference; and
combining a received signal across a set of receive antennas of the device with the at least one selected spatial direction.

21. The method of claim 20, further comprising enabling an additional receive antenna to receive the signal to identify in-device interference to be cancelled.

22. The method of claim 20, wherein calculating the spatial covariance matrix comprises calculating the spatial covariance matrix based on the in-device interference generated by a transmit antenna of the device.

23. The method of claim 20, wherein the calculating occurs when an uplink signal is present in the device.

24. The method of claim 20, wherein the at least one spatial direction comprises an Eigenvector and wherein each of the at least one first value and the second value comprises an Eigenvalue.

25. The method of claim 20, further comprising:
detecting, at the device, a dominant spatial direction of the in-device interference based on the calculating and the selecting; and
determining whether to bypass a transmit filter of the device based on an energy level associated with the dominant spatial direction of the in-device interference.

26. The method of claim 25, wherein determining whether to bypass the transmit filter is further based on when a transmit power for transmission by the device is above a threshold.

27. An apparatus for in-device interference cancellation, comprising:
a memory;
a transceiver configured for wireless communication; and
at least one processor coupled to the memory and the transceiver, the at least one processor configured:
to calculate a spatial covariance matrix at a device when no desired incoming downlink signal from another device is present;
to select at least one spatial direction, computed from the spatial covariance matrix, associated with at least one first value corresponding to strength of in-device interference smaller than a second value corresponding to strength of dominant in-device interference; and
to combine a received signal across a set of receive antennas of the device with the at least one selected spatial direction.

28. The apparatus of claim 27, wherein the at least one processor is further configured to enable an additional receive antenna to receive the signal to identify the in-device interference to be cancelled.

29. The apparatus of claim 27, wherein the at least one processor is further configured to calculate the spatial covariance matrix based on the in-device interference generated by a transmit antenna of the device.

30. The apparatus of claim 27, wherein the at least one processor is further configured to calculate the spatial covariance matrix when an uplink signal is present in the device.
